(19) United States
(12) Patent Application Publication
(10) Pub. No.: US 2008/0186293 A1
(43) Pub. Date: Aug. 7, 2008

(54) Display device including wiring board

(75) Inventors: Kazuaki Igarashi, Hakusan-shi (JP); Hirokazu Okamoto, Himeji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TOSHIBA MATSUSHITA DISPLAY TECHNOLOGY CO., LTD.

(21) Appl. No.: 11/902,464

(22) Filed: Sep. 21, 2007

(30) Foreign Application Priority Data
Sep. 29, 2006 (JP) 2006-268903

(51) Int. Cl. G09G 3/00

(52) U.S. Cl. 345/206

(57) ABSTRACT

A display device includes a display panel including a display area, a first driving IC chip and a second driving IC chip, which are disposed with an interval along an end edge of the display panel, a cascade wiring line which connects the first driving IC chip and the second driving IC chip on the display panel, and a wiring board with a comb-shaped end portion having a first projection portion and a second projection portion, the wiring board being connected to the display panel such that the first projection portion and the second projection portion are electrically connected to the first driving IC chip and the second driving IC chip, with the cascade wiring line being interposed between the first projection portion and the second projection portion, wherein the cascade wiring line is exposed from the wiring board.

### CROSS-REFERENCE TO RELATED APPLICATIONS

This application is based upon and claims the benefit of priority from prior Japanese Patent Application No. 2006-268903, filed Sep. 29, 2006, the entire contents of which are incorporated herein by reference.

### BACKGROUND OF THE INVENTION

1. Field of the Invention

The present invention relates generally to a display device including a wiring board, and more particularly to a display device in which a driving IC (integrated circuit) chip is amounted by a COG (chip on glass) method.

2. Description of the Related Art

Flat-panel display devices, such as liquid crystal display devices, have widely been used as monitor displays of computers, car navigation systems, TV receivers, etc. The flat-panel display device includes a display panel having a display area for displaying an image, and a control circuit which controls the display panel.

In recent years, a COG method has been developed, wherein a driving IC chip having a part of the function of a control circuit is directly mounted on a glass substrate that composes the display panel. Various layouts of a plurality of driving IC chips have been proposed. In particular, Jpn. Pat. Appln. KOKAI Publication No. 2006-030949 proposes a layout in which a plurality of driving IC chips are cascade-connected.

In the display device in which the plural driving IC chips are mounted by the COG method, a large picture-frame size is needed in order to suppress the impedance of wiring lines for connecting the driving IC chips, that is, cascade wiring lines (e.g. signal bus wiring lines and reference voltage bus wiring lines). In addition, in the case where a wiring board is connected via an anisotropic conductive film (ACF) to an end side of the display panel on which the cascade wiring lines are disposed, the wiring board is disposed more on the substrate end side than the cascade wiring lines so that the wiring board may not overlap the cascade wiring lines, thereby to avoid short-circuit or line breakage of the cascade wiring lines due to electrically conductive particles included in the anisotropic conductive film. Thus, the picture-frame size of the substrate, on which the cascade wiring lines are disposed, tends to increase. In the case of the design in which a plurality of display devices are cut out of a mother glass, this leads to a decrease in number of display devices cut out of the mother glass, an increase in outside size of each display device, and an increase in manufacturing cost.

### BRIEF SUMMARY OF THE INVENTION

The present invention has been made in consideration of the above-described problems, and the object of the invention is to provide a display device which realizes reduction in picture-frame size, enhancement in reliability and reduction in manufacturing cost.

According to an aspect of the invention, there is provided a display device comprising: a display panel including a display area; a first driving IC chip and a second driving IC chip, which are disposed with an interval along an end edge of the display panel; a cascade wiring line which connects the first driving IC chip and the second driving IC chip on the display panel; and a wiring board with a comb-shaped end portion having a first projection portion and a second projection portion, the wiring board being connected to the display panel such that the first projection portion and the second projection portion are electrically connected to the first driving IC chip and the second driving IC chip, with the cascade wiring line being interposed between the first projection portion and the second projection portion, wherein the cascade wiring line is exposed from the wiring board.

The present invention can provide a display device which realizes reduction in picture-frame size, enhancement in reliability and reduction in manufacturing cost.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 schematically shows the structure of a display device according to an embodiment of the present invention;

FIG. 2 is a cross-sectional view schematically showing the structure of a liquid crystal display panel which is a structural component of a liquid crystal display device that is an example of the display device;

FIG. 3 shows an example of a structure for preventing interference with cascade wiring lines in a case of using a wiring board having a straight end portion;

FIG. 4 shows an example of a structure for reducing a picture-frame size in a case of using a wiring board having a straight end portion;

FIG. 5 schematically shows the structure of a wiring board according to the embodiment of the invention;

FIG. 6 is a schematic cross-sectional structural view, taken along line VI-VI in FIG. 5;

FIG. 7 is a schematic cross-sectional structural view, taken along line VII-VII in FIG. 5;

FIG. 8 is a view for describing connection between insulating substrate-side bumps and wiring board-side lines by means of an anisotropic conductive film;

FIG. 9 schematically shows the structure of a wiring board according to another embodiment of the invention;

FIG. 10 is a perspective view schematically showing the structure of a wiring board that is applicable to the embodiment of the invention;

FIG. 11 is a cross-sectional view schematically showing the structure of another wiring board that is applicable to the embodiment of the invention; and

FIG. 12 is a perspective view schematically showing the structure of the wiring board shown in FIG. 11.

### DETAILED DESCRIPTION OF THE INVENTION

A display device according to an embodiment of the present invention, for example, an active matrix liquid crystal display device, will now be described with reference to the accompanying drawings.

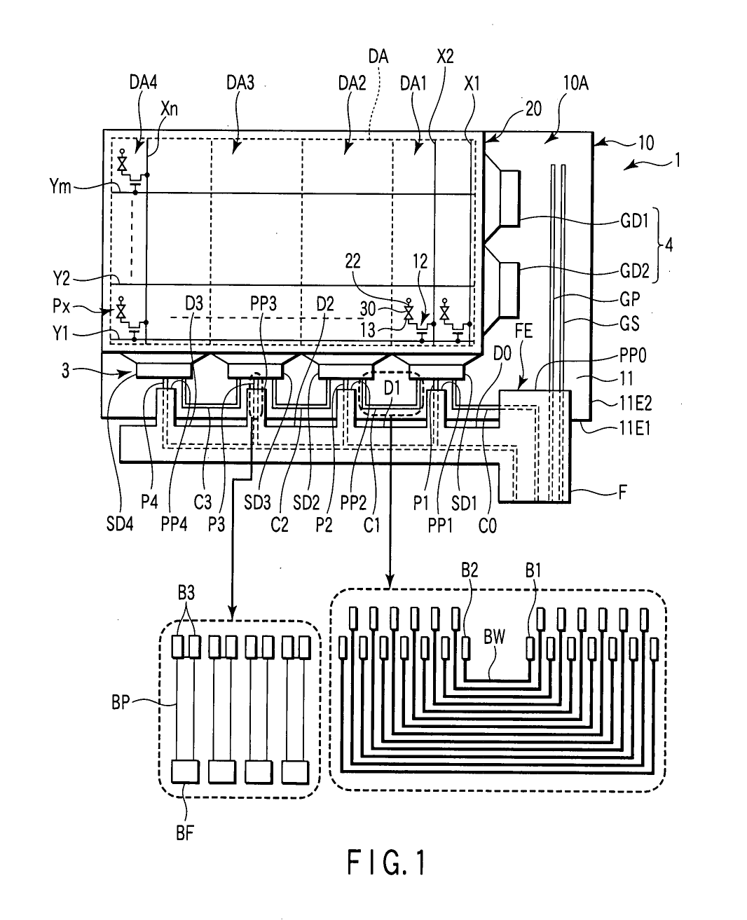

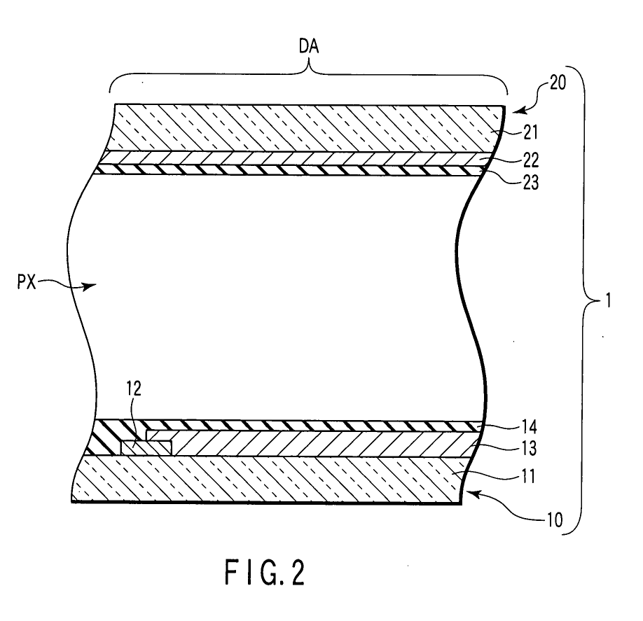

As is shown in FIG. 1 and FIG. 2, the liquid crystal display device is configured to include a display panel 1 having a display area DA that displays an image, and a wiring board (e.g. flexible printed circuit) F that is connected to the display panel 1. The wiring board F includes wiring lines which are electrically connected to the display panel 1 via an anisotropic conductive film (ACF) (not shown). In the liquid crystal display device, the display panel 1 is a liquid crystal display panel which is configured such that a liquid crystal layer 30 is held between a pair of substrates, namely, an array substrate 10 and a counter-substrate 20. The display area DA is composed of a plurality of pixels PX which are arrayed in a matrix.

The array substrate 10 is formed by using a light-transmissive insulating substrate 11 such as a glass substrate. The array substrate 10 includes, on the insulating substrate 11, a plurality of scanning lines Y (Y1 to Ym) which are disposed along rows of pixels PX; a plurality of signal lines X (X1 to Xn) which are disposed along columns of the pixels PX; switching elements 12 which are disposed near intersections between the scanning lines Y and signal lines X in association with the individual pixels PX; and pixel electrodes 13 which are connected to the associated switching elements 12. The scanning lines Y and signal lines X are disposed in different layers via an insulation layer.

Each of the switching elements 12 is composed of, e.g. a thin-film transistor. The switching element 12 includes a semiconductor layer of, e.g. amorphous silicon or polysilicon. The switching element 12 has a gate connected to the associated scanning line Y (or formed integral with the scanning line Y). The switching element 12 has a source connected to the associated signal line X (or formed integral with the signal line X). The switching element 12 has a drain electrically connected to the associated pixel electrode 13 (or formed integral with the pixel electrode 13).

In the case of a transmissive liquid crystal display device which selectively passes backlight and displays an image, the pixel electrode 13 is formed of a light-transmissive electrically conductive material such as indium tin oxide (ITO) or indium zinc oxide (IZO). In the case of a reflective liquid crystal display device which selectively reflects ambient light that is incident from the counter-substrate 20 side and displays an image, the pixel electrode 13 is formed of a light-reflective electrically conductive material such as aluminum (Al). At least the surface of the display area DA of the array substrate 10 with this structure is covered with an alignment film 14 that controls the alignment of liquid crystal molecules included in the liquid crystal layer 30.

The counter-substrate 20 is formed by using a light-transmissive insulating substrate 21 such as a glass substrate. The counter-substrate 20 includes, in the display area DA on the insulating substrate 21, a counter-electrode 22 which is disposed to be opposed to the plural pixel electrodes 13. The counter-electrode 22 is formed of a light-transmissive electrically conductive material such as ITO. At least the surface of the display area DA of the counter-substrate 20 with this structure is covered with an alignment film 23 that controls the alignment of liquid crystal molecules included in the liquid crystal layer 30.

The array substrate 10 and counter-substrate 20 are disposed in the state in which the pixel electrodes 13 are opposed to the counter-electrode 22, and a gap is provided therebetween. The liquid crystal layer 30 is formed of a liquid crystal composition which is sealed in the gap between the array substrate 10 and counter-substrate 20. In this embodiment, the liquid crystal mode is not restricted. Applicable modes are, for instance, a TN (Twisted Nematic) mode, an OCB (Optically Compensated Birefringence) mode, a VA (Vertical Aligned) mode, and an IPS (In-Plane Switching) mode.

In the case of a liquid crystal display device of a color display type, the display panel 1 includes a plurality of kinds of pixels, for instance, a red pixel that displays red (R), a green pixel that displays green (G), and a blue pixel that displays blue (B). Specifically, the red pixel includes a red color filter that passes light with a principal wavelength of red. The green pixel includes a green color filter that passes light with a principal wavelength of green. The blue pixel includes a blue color filter that passes light with a principal wavelength of blue. These color filters are disposed on the major surface of the array substrate 10 or counter-substrate 20.

The display device according to this embodiment includes a driving section which outputs various signals to the display panel 1. The driving section is disposed on an outer peripheral part that is located outside the display area DA of the display panel 1. Specifically, the driving section includes a signal line driving unit 3 which supplies driving signals (video signals) to the respective signal lines X in the display area DA, and a scanning line driving unit 4 which supplies driving signals (scanning signals) to the respective scanning lines Y in the display area DA. In the example shown in FIG. 1, the signal line driving unit 3 and scanning line driving unit 4 are disposed on an extension section 10A of the array substrate 10 in the outer peripheral part, which extends outward from end portions of the counter-substrate 20.

To be more specific, in this embodiment, the signal line driving unit 3 includes four driving IC chips SD1, SD2, SD3 and SD4. The scanning line driving unit 4 includes two driving IC chips GD1 and GD2. These driving IC chips are driven by power that is supplied from the wiring board F, and outputs driving signals, which are necessary for driving the pixels PX, to the associated signal supply lines (i.e. signals lines and scanning lines) on the basis of the various signals supplied from the wiring board F.

The driving IC chips SD1 to SD4 are disposed substantially linearly with intervals along an end edge of the display panel 1, to be more specific, an end edge 11E1 of the insulating substrate 11 that composes the array substrate 10. The driving IC chips GD1 and GD2 are disposed substantially linearly with intervals along an end edge 11E2 of the insulating substrate 11.

These driving IC chips are electrically connected to bumps formed on the insulating substrate 11 via an anisotropic conductive film, and are mechanically connected to the insulating substrate 11. Similarly, the wiring board F is electrically connected to bumps formed on the insulating substrate 11 via an anisotropic conductive film, and is mechanically connected to the insulating substrate 11.

At least in the signal line driving unit 3, the neighboring driving IC chips are connected by cascade wiring lines disposed on the insulating substrate 11. Specifically, the driving IC chip SD1 and driving IC chip SD2 are connected by a cascade wiring line C1. Similarly, the driving IC chip SD2 and driving IC chip SD3 are connected by a cascade wiring line C2, and the driving IC chip SD3 and driving IC chip SD4 are connected by a cascade wiring line C3.

The input side of the driving IC chip SD1 is connected to the wiring board F via a wiring line C0 which is formed on the insulating substrate 11. Various signals from the wiring board F are supplied via the wiring line C0. The wiring line C0 and cascade wiring lines C1 to C3 correspond to bus lines such as a signal bus line and a reference voltage bus line.

As shown in FIG. 1 in enlarged scale, each of the cascade wiring lines C1 to C3 corresponds to bus lines BW for connecting bumps B1, which are connected to one driving IC chip (e.g. SD1), and bumps B2, which are connected to another driving IC chip (e.g. SD2). Thereby, signals and reference voltages, which are output from one driving IC chip, are input to another driving IC chip from the bumps B2 via the bumps B1 and bus lines BW. In short, the cascade wiring line is used in order to transfer substantially identical signals between neighboring driving IC chips.

In addition, in the signal line driving unit 3, the driving IC chips SD1 to SD4 are connected to power bus lines which are disposed adjacent to the cascade wiring lines on the insulating substrate 11. Specifically, the driving IC chip SD1 is connected to a power bus line P1 which is disposed between the wiring line C0 and the cascade wiring line C1. Similarly, the driving IC chip SD2 is connected to a power bus line P2 which is disposed between the cascade wiring line C1 and the cascade wiring line C2. The driving IC chip SD3 is connected to a power bus line P3 which is disposed between the cascade wiring line C2 and the cascade wiring line C3, and the driving IC chip SD4 is connected to a power bus line P4 which is disposed adjacent to the cascade wiring line C3.

As shown in FIG. 1 in enlarged scale, each of the power bus lines P1 to P4 corresponds to bus lines BP for connecting bumps B3, which are connected to the driving IC chip (e.g. SD3), and bumps BF which are connected to the wiring board F. Thereby, power is supplied from the wiring board F to the driving IC chips SD1 to SD4.

With the above structure, various signals, which are output from the wiring board F, are input to the driving IC chip SD1 via the wiring line C0. Thereby, the driving IC chip SD1 outputs driving signals to the signal lines X that are disposed in association with the pixels PX in a first area DA1 of the display area DA. The signals, which are output from the driving IC chip SD1, are input to the driving IC chip SD2 via the cascade wiring line C1. Thereby, the driving IC chip SD2 outputs driving signals to the signal lines X that are disposed in a second area DA2 neighboring the first area DA1.

The signals, which are output from the driving IC chip SD2, are input to the driving IC chip SD3 via the cascade wiring line C2. Thereby, the driving IC chip SD3 outputs driving signals to the signal lines X that are disposed in a third area DA3 neighboring the second area DA2. The signals, which are output from the driving IC chip SD3, are input to the driving IC chip SD4 via the cascade wiring line C3. Thereby, the driving IC chip SD4 outputs driving signals to the signal lines X that are disposed in a fourth area DA4 neighboring the third area DA3.

On the other hand, the driving IC chips GD1 and GD2 are connected to the wiring board F via a signal bus line GS and a power bus line GP, which are disposed on the insulating substrate 11. Thereby, the driving IC chip GD1 outputs driving signals to the scanning lines Y which are disposed in association with the pixels PX in a substantially upper half area of the display area DA. Similarly, the driving IC chip GD2 outputs driving signals to the scanning lines Y which are disposed in association with the pixels PX in a substantially lower half area of the display area DA.

In the meantime, in the case of using the wiring board F with a straight end portion that is connected to the display panel 1, problems to be described below will arise. A description is given, paying attention to the positional relationship between the cascade wiring line C1, which is disposed between the driving IC chips SD1 and SD2, and the power bus line P2 for supplying power to the driving IC chip SD2.

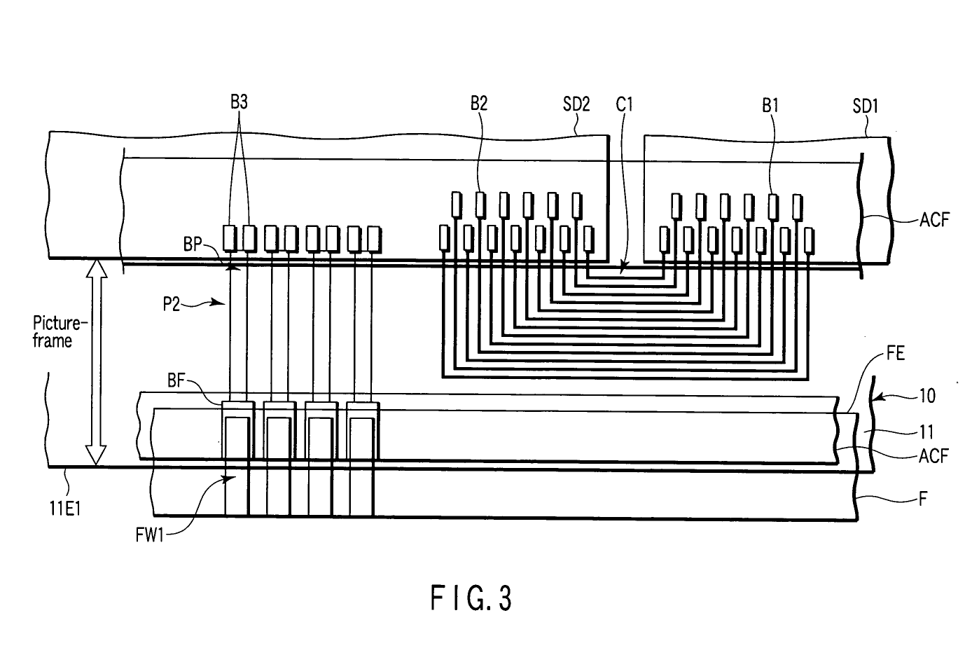

In an example shown in FIG. 3, on the insulating substrate 11 that composes the array substrate 10, the bumps BF, which are connected to the power bus line P2, are not arranged in line with the cascade wiring line C1, and are disposed more on the end edge 11E1 side of the insulating substrate 11 than the cascade wiring line C1. The wiring board F has a straight end portion FE, and includes first wiring lines FW1 that are led out to the end portion FE. The first wiring lines FW1 are connected to the bumps BF. The wiring board F supplies power to the driving IC chip via the first wiring lines FW1.

With this positional relationship, the anisotropic conductive film ACF, which is interposed between the bumps BF and the first wiring lines FW1, is disposed along the end edge 11E1 of the insulating substrate 11 and does not overlap the cascade wiring line C1. This arrangement is adopted in order to avoid interference between a pressure-bonding tool, which is used at a time of pressure-bonding the wiring board F, and the cascade wiring line C1, and to prevent short-circuit or line breakage of the cascade wiring line C1 due to electrically conductive particles included in the anisotropic conductive film ACF. With this arrangement, however, the picture-frame size increases.

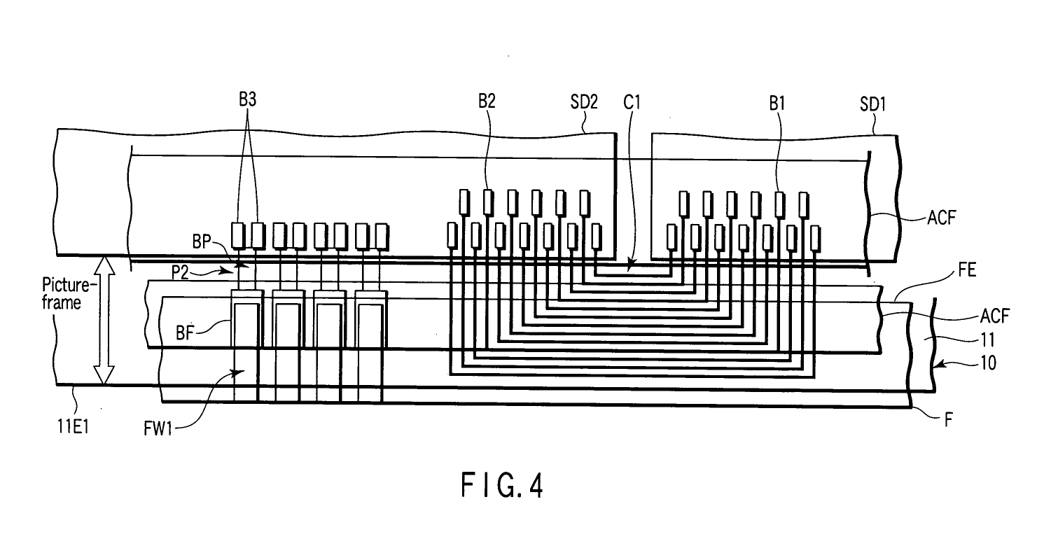

In an example shown in FIG. 4, on the insulating substrate 11, the bumps BF are arranged adjacent to the cascade wiring line C1 in line with the cascade wiring line C1. This arrangement is adopted in order to make the picture-frame size less than in the example shown in FIG. 3. With this arrangement, however, the anisotropic conductive film ACF, which is interposed between the bumps BF and the first wiring lines FW1, is disposed so as to overlap not only the bumps BF but also the cascade wiring line C1. As a result, when the wiring board F is pressure-bonded, the pressure-bonding tool interferes with the cascade wiring line C1. Consequently, the electrically conductive particles included in the anisotropic conductive film ACF press the cascade wiring line C1, and there is a possibility that the cascade wiring line C1 may be broken or the wires of the cascade wiring line C1 may be short-circuited by the electrically conductive particles.

In the present embodiment, in order to avoid the above problems, use is made of a comb-shaped wiring board F with an end portion that is connected to the display panel 1 and includes a first projection portion and a second projection portion. This wiring board F is connected to the display panel 1 in such a fashion that the cascade wiring line is interposed between the first projection portion and the second projection portion, and the first projection portion and the second projection portion are electrically connected to the first driving IC chip and the second driving IC chip. In this case, the cascade wiring line is exposed from the wiring board F. In short, the cascade wiring line and the wiring board F do not overlap.

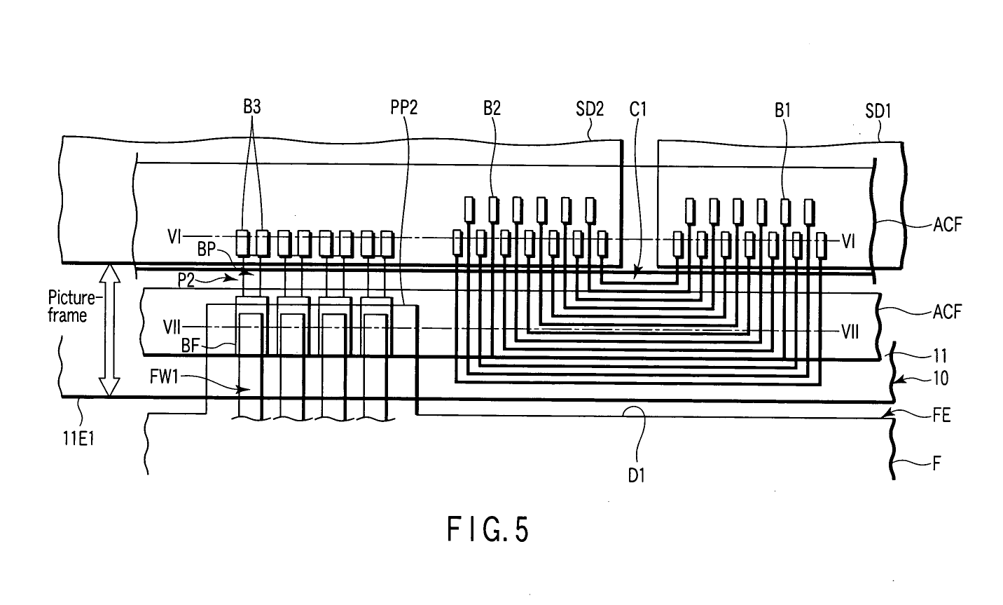

Specifically, as shown in FIG. 5, on the insulating substrate 11, the bumps BF are arranged adjacent to the cascade wiring line C1 in line with the cascade wiring line C1. Not only the bumps BF connected to the power bus line P2, but also the bumps connected to the other power bus lines P1, P3 and P4 are arranged adjacent to the other cascade wiring lines in line with the cascade wiring lines. In connection with this positional relationship, in the present embodiment, as shown in FIG. 5, the wiring board F having a comb-shaped end portion FE is employed.

Specifically, this wiring board F, as shown in FIG. 1, includes four projection portions PP1 to PP4 for supplying power to the four driving IC chips SD1 to SD4. Further, the wiring board F includes a projection portion PP0 which is connected to the signal bus line GS, power bus line GP and wiring line C0. Each of the projection portions PP1 to PP4 includes first wiring lines FW1 which are connected to the associated driving IC chip. Moreover, the wiring board F includes three recess portions D1 to D3 in association with the three cascade wiring lines C1 to C3, and a recess portion D0 in association with the wiring line C0.

To be more specific, the projection portion PP1 is connected to the power bus line P1 which supplies power to the driving IC chip SD1. Similarly, the projection portion PP2 is connected to the power bus line P2 which supplies power to the driving IC chip SD2, the projection portion PP3 is connected to the power bus line P3 which supplies power to the driving IC chip SD3, and the projection portion PP4 is connected to the power bus line P4 which supplies power to the driving IC chip SD4.

The recess portion D1 is formed so as to expose the cascade wiring line C1 between the projection portion PP1 and projection portion PP2. Similarly, the recess portion D2 is formed so as to expose the cascade wiring line C2 between the projection portion PP2 and projection portion PP3, and the recess portion D3 is formed so as to expose the cascade wiring line C3 between the projection portion PP3 and projection portion PP4. In addition, the recess portion D0 is formed so as to expose the wiring line C0 between the projection portion PP0 and projection portion PP1. In short, none of the cascade wiring lines C1 to C3 and the wiring line C0 overlaps the wiring board F.

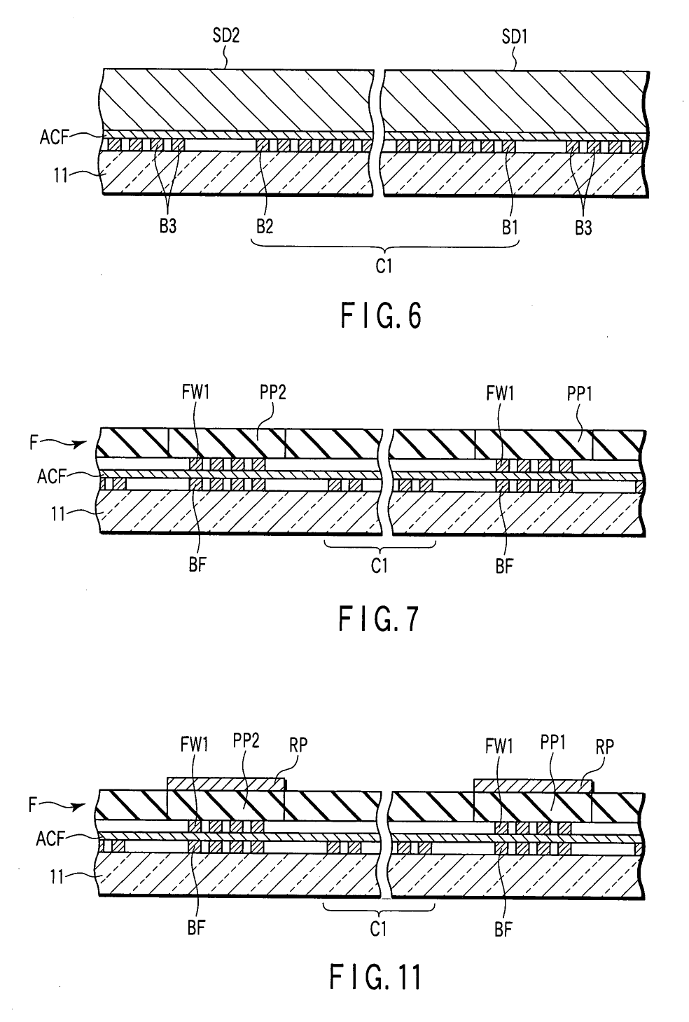

As shown in FIG. 6, the driving IC chips are electrically connected via the anisotropic conductive film ACF to the bumps B1 and B2 that are disposed on the insulating substrate 11 and connected to the cascade wiring lines (e.g. signal bus lines and reference voltage bus lines), and to the bumps B3 connected to the power bus lines. As shown in FIG. 7, the first wiring lines FW1, which are formed on the projection portions of the wiring board F, are electrically connected via the anisotropic conductive film ACF to the bumps BF that are connected to the power bus lines.

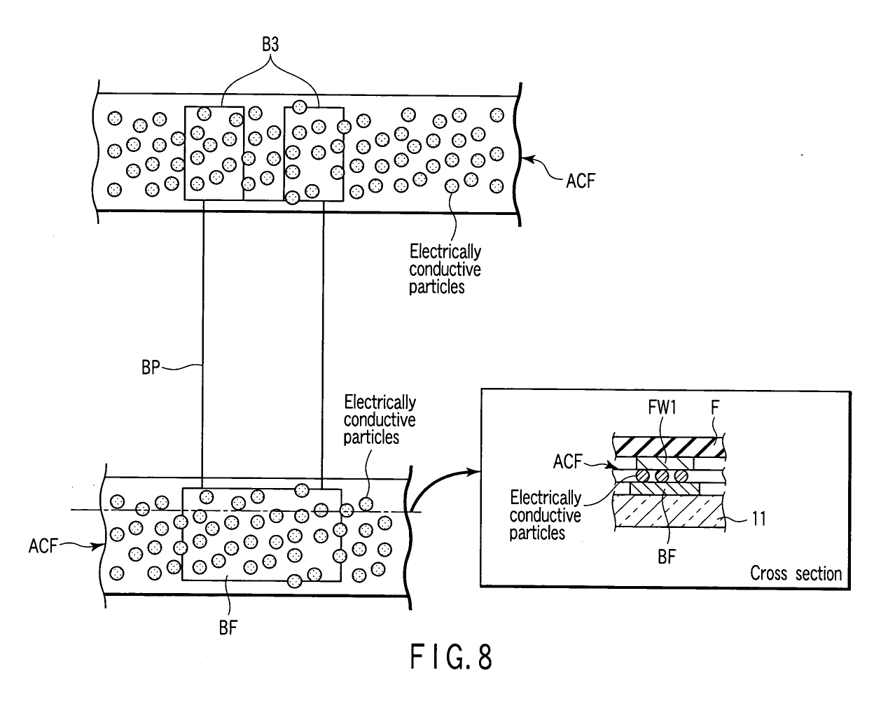

As shown in FIG. 8, the anisotropic conductive film ACF includes a great number of electrically conductive particles in an adhesive, and is disposed, for example, between the bumps BF on the insulating substrate 11 and the first wiring lines FW1 of the wiring board F. In this state, by heating the anisotropic conductive film ACF while pressurizing it by means of a pressure-bonding tool, the adhesive is melted to bond the insulating substrate 11 and the wiring board F. In addition, the electrically conductive particles bite into the bumps BF and first wiring lines FW1, thereby electrically connecting the bumps BF and first wiring lines FW1.

According to the present embodiment, the picture-frame size can be made less than in the example shown in FIG. 3. The picture-frame size of the insulating substrate 11 in the example shown in FIG. 5 (i.e. the distance from the driving IC chip, which is connected to the insulating substrate 11, to the end edge 11E1 of the insulating substrate 11) was successfully reduced by 1 mm or more, compared to the example shown in FIG. 3. Thus, the number of display devices cut out of the mother glass can be increased and the manufacturing cost can be reduced.

The anisotropic conductive film ACF, which is interposed between the bumps BF and the first wiring lines FW1, overlaps not only the bumps BF but also the cascade wiring line C1, but the wiring board F does not overlap the cascade wiring line C1. Thus, when the wiring board F is pressure-bonded on the insulating substrate 11, it is possible to prevent the anisotropic conductive film ACF on the cascade wiring line C1 from being pressed by the pressure-bonding tool, and to prevent short-circuit or line breakage of the cascade wiring line C1 due to the electrically conductive particles included in the anisotropic conductive film ACF.

It is also possible to secure a region with a sufficient area for forming the cascade wiring line, without overlap with the wiring board F, and to suppress impedance (200Ω, 2.5 pF or less). Therefore, the reliability of connection of wiring lines can be enhanced when the wiring board and the insulating substrate are pressure-bonded.

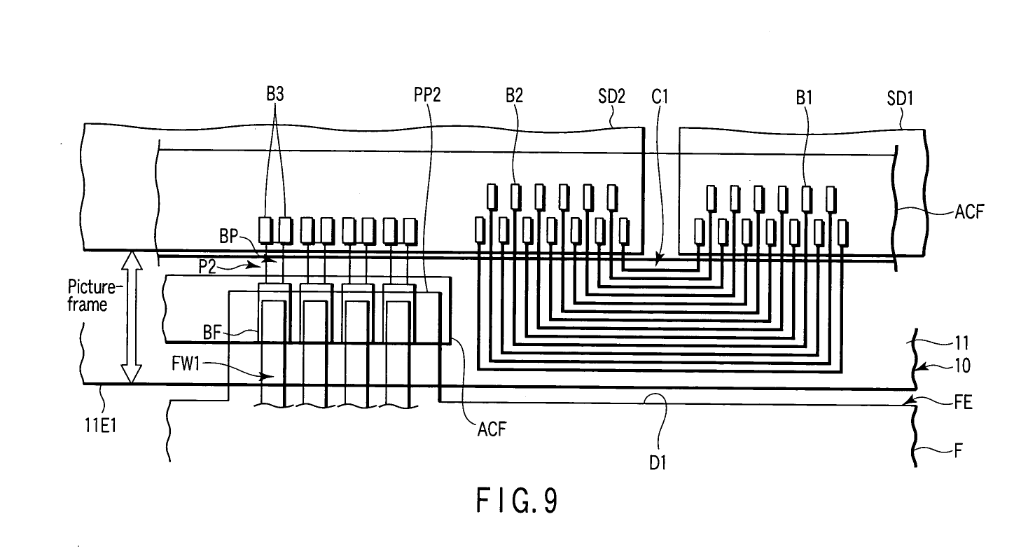

In the above-described embodiment, the anisotropic conductive film ACF, which extends in a strip shape along the end edge 11E1 of the insulating substrate 11, is disposed as the anisotropic conductive film ACF for connecting the bumps BF and first wiring lines FW1. Alternatively, as shown in FIG. 9, the anisotropic conductive film ACF may be disposed only on the parts corresponding to the projection portions of the wiring board F. Specifically, the anisotropic conductive film ACF is disposed in an island shape in association with each of the projection portions PP1 to PP4, and is interposed between each projection and the bumps BF connected to each of the power bus lines P1 to P4. Thus, the cascade wiring lines C1 to C3 are exposed from the anisotropic conductive films ACF.

By adopting the above-described anisotropic conductive film ACF, it becomes possible to prevent short-circuit or line breakage of the cascade wiring line due to the electrically conductive particles included in the anisotropic conductive film ACF, even if the pressure-bonding tool comes in contact with the cascade wiring line. Moreover, the tool is not contaminated with the adhesive of the anisotropic conductive film ACF.

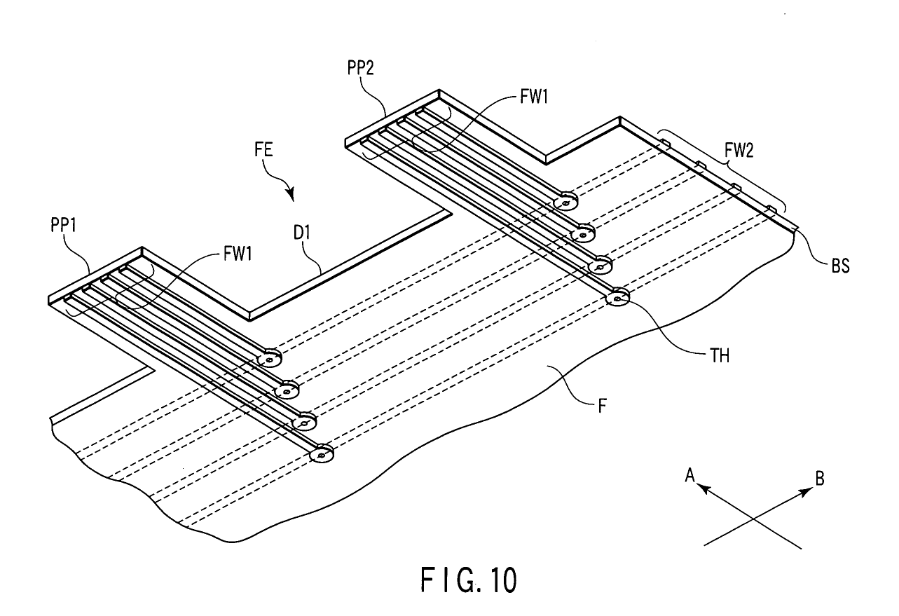

In the above-described embodiment, the wiring board F is configured such that wiring lines are formed on one side of a base film of the wiring board F. Alternatively, as shown in FIG. 10, a wiring board F, in which wiring lines are formed on both sides of a base film BS, may be adopted.

Specifically, the wiring board F includes first wiring lines FW1 which are disposed on one surface of the base film BS, and second wiring lines FW2 which are disposed on the other surface of the base film BS. The first wiring lines FW1 are disposed in a first direction A on the base film BS, and extend toward distal ends of the projection portions PP1 to PP4. The first wiring lines FW1 disposed on the respective projection portions are connected to the associated driving IC chips. On the other hand, the second wiring lines FW2 are disposed in a second direction B (e.g. perpendicular to the first direction A) on the base film BS. The second wiring lines FW2 are electrically connected to the first wiring lines FW1 via through-holes TH which penetrate the base film BS.

According to the wiring board F with this structure, the length of each wiring line can be reduced, and the planar area size of the wiring board F can be reduced.

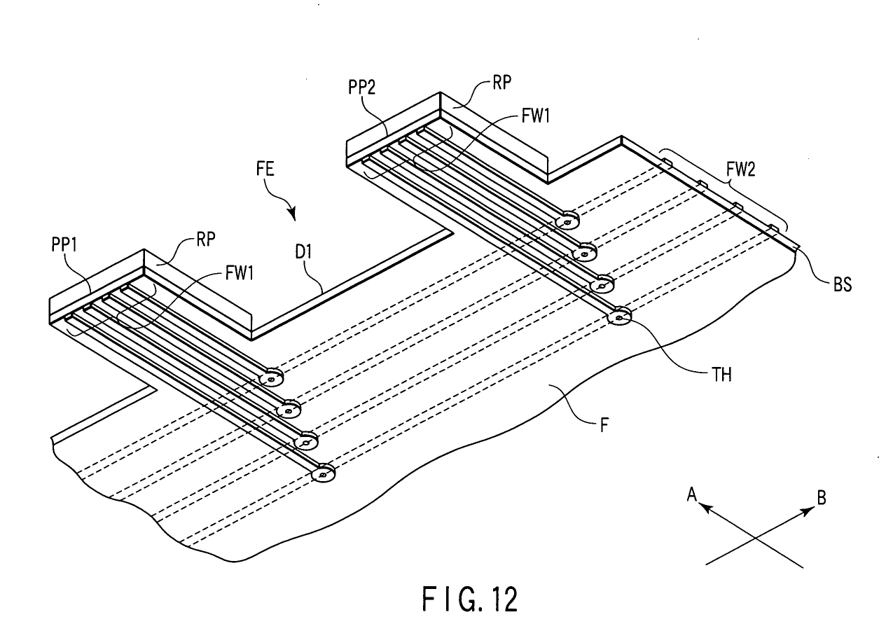

In the present embodiment, as shown in FIG. 11 and FIG. 12, the projection portions PP1 to PP4 at the end edge FE of the wiring board F may be covered with heat-resistant reinforcement plates RP. The reinforcement plates RP are formed of a material with high heat resistance, such as polytetrafluoroethylene resin (Teflon™).

With the provision of the reinforcement plate RP, the height of the projection portion from the base film BS can be increased. Thus, when the projection portion is pressure-bonded on the insulating substrate 11 by means of the pressure-bonding tool, a sufficient pressure can be applied to the projection portion. Besides, even if the anisotropic conductive film overlaps the cascade wiring line, as shown in FIG. 5, it becomes possible to prevent the pressure of the pressure-bonding tool from acting on the anisotropic conductive film on the cascade wiring line. Moreover, at the time of pressure-bonding, bending of the projection portion can be prevented.

The present invention is not limited directly to the above-described embodiments. In practice, the structural elements can be modified without departing from the spirit of the invention. Various inventions can be made by properly combining the structural elements disclosed in the embodiments. For example, some structural elements may be omitted from all the structural elements disclosed in the embodiments. Furthermore, structural elements in different embodiments may properly be combined.

In the above-described embodiments, the liquid crystal display device has been exemplified as the display device. Needless to say, the present invention can be applied to other types of display devices having driving ICs mounted by the COG method, such as organic electroluminescence display devices.

What is claimed is:

1. A display device comprising:
a display panel including a display area;
a first driving IC chip and a second driving IC chip, which are disposed with an interval along an end edge of the display panel;
a cascade wiring line which connects the first driving IC chip and the second driving IC chip on the display panel; and
a wiring board with a comb-shaped end portion having a first projection portion and a second projection portion, the wiring board being connected to the display panel such that the first projection portion and the second projection portion are electrically connected to the first driving IC chip and the second driving IC chip, with the cascade wiring line being interposed between the first projection portion and the second projection portion,
wherein the cascade wiring line is exposed from the wiring board.

2. The display device according to claim 1, wherein the first projection portion and the second projection portion are connected via an anisotropic conductive film, and
the cascade wiring line is exposed from the anisotropic conductive film.

3. The display device according to claim 1, wherein each of the first projection portion and the second projection portion is covered with a reinforcement plate having heat resistance.

4. The display device according to claim 3, wherein the reinforcement plate is formed of polytetrafluoroethylene resin.

5. The display device according to claim 1, wherein the wiring board includes first wiring lines which are disposed on one surface of a base film, extend to the first projection portion and the second projection portion, and are connected to the first driving IC chip and the second driving IC chip, and second wiring lines which are disposed on the other surface of the base film and are electrically connected to the first wiring lines via through-holes.

6. The display device according to claim 5, further comprising:
bumps which are disposed adjacent to the cascade wiring line on the display panel, and are connected to power bus lines which supply power to the first driving IC chip and the second driving IC chip,
wherein the first wiring lines are connected to the bumps.

7. The display device according to claim 1, wherein the display panel includes, in the display area, scanning lines which are disposed along rows of pixels that are arrayed in a matrix, signal lines which are disposed along columns of the pixels, and switching elements which are disposed at intersections between the scanning lines and the signal lines, and
at least a part of a signal line driving unit, which supplies driving signals to the signal lines, is composed of the first driving IC chip and the second driving IC chip.

8. The display device according to claim 1, wherein the display panel is a liquid crystal display panel in which a liquid crystal layer is held between a pair of substrates.

9. A wiring board which is connected to a display panel, the wiring board comprising a comb-shaped end portion having a recess portion and a projection portion,
wherein the projection portion includes a wiring line which is electrically connected to the display panel via an anisotropic conductive film, and
the recess portion is formed in a manner that a wiring line on the display panel is exposed when the wiring board is connected to the display panel.
